(19) United States
(12) Patent Application Publication
(10) Pub. No.: US 2023/0163364 A1
(43) Pub. Date: May 25, 2023

(54) ALL-SOLID-STATE BATTERY AND METHOD FOR PRODUCING IT

(71) Applicants: TOYOTA JIDOSHA KABUSHIKI KAISHA, Toyota-shi Aichi-ken (JP); Panasonic Holdings Corporation, Kadoma-shi Osaka (JP)

(72) Inventors: Masahiro Iwasaki, Nagoya-shi Aichi-ken (JP); Yuichi Hasegawa, Otsu-shi Shiga-ken (JP); Ryo Sugawara, Nishinomiya-shi Hyogo-ken (JP)

(73) Assignees: TOYOTA JIDOSHA KABUSHIKI KAISHA, Toyota-shi Aichi-ken (JP); Panasonic Holdings Corporation, Kadoma-shi Osaka (JP)

(21) Appl. No.: 17/989,124

(22) Filed: Nov. 17, 2022

(30) Foreign Application Priority Data
Nov. 24, 2021 (JP) 2021-190443

(51) Int. Cl. H01M 10/0585; H01M 50/534; H01M 4/62; H01M 10/0562; H01M 4/66

(52) U.S. Cl. CPC H01M 10/0585; H01M 50/534; H01M 4/62; H01M 10/0562; H01M 4/669; H01M 4/661; H01M 2300/0068; H01M 2004/027

(57) ABSTRACT

The present disclosure provides an all-solid-state battery with a novel structure. The all-solid-state battery of the disclosure is an all-solid-state battery having at least one structural unit cell comprising a positive electrode collector layer, a positive electrode active material layer, a solid electrolyte layer, a negative electrode active material layer and a negative electrode collector layer stacked in that order, wherein a connecting conductor layer is layered on the surface of the positive electrode collector layer side and/or the negative electrode collector layer side of the structural unit cell. The electric resistivity of the connecting conductor layer is lower than the electric resistivity of the positive electrode collector layer or negative electrode collector layer on which the connecting conductor is layered. The electric resistivity of the connecting conductor layer is 1×10⁻⁶ Ωm or lower.

### CROSS-REFERENCE TO RELATED APPLICATION

This application claims priority to Japanese Patent Application No. 2021-190443 filed Nov. 24, 2021, which is incorporated herein by reference in its entirety.

### FIELD

The present disclosure relates to an all-solid-state battery and to a method for producing it.

### BACKGROUND

All-solid-state batteries have a construction in which the separator layer and electrolyte solution used in a conventional electrolyte solution lithium ion battery are replaced with a solid electrolyte, and due to the high flame retardance of the solid electrolyte and lack of requirement for a cooling unit, they are expected to have high pack energy density and to allow high rate charging, thus being highly suitable for use in automobiles.

In terms of all-solid-state battery structure, PTL 1 discloses a structure wherein unit cells each having a positive electrode layer formed on one side of a solid electrolyte and a negative electrode layer formed on the other side, are stacked across positive electrode collectors and negative electrode collectors, the positive electrode collectors being commonly connected to a positive electrode terminal and the negative electrode collectors being commonly connected to a negative electrode terminal, and the terminals leading out of the battery. One problem with this construction, however, is that the internal resistance of the cell increases due to electrical resistance at the connected sections between the collectors and terminals.

To counter this, PTL 2 discloses a stacked all-solid-state battery structure wherein the positive electrode collector has each of the positive electrode layers of the electrode stack disposed in a folded manner so as to be electrically connected together, and the negative electrode collector has each of the negative electrode layers of the electrode stack disposed in a folded manner so as to be electrically connected together. This can reduce electrical resistance at the connected sections between the positive electrodes and negative electrode collectors and the terminals, in a conventional construction. However, this structure has been problematic because it requires complex production steps.

Another issue is that the electrical resistance may increase due to copper sulfide formation if sulfur is included in the solid electrolyte and copper is used as the collector. PTL 3 discloses an all-solid-state battery with reduced copper sulfide formation and excellent conductivity, wherein the solid electrolyte has a negative electrode collector for an all-solid-state battery with a nickel film formed on both sides of an electrolytic copper foil, rolled copper foil or copper alloy foil, and a sulfur-containing solid electrolyte. However, since the layered stack is entirely joined in this structure, it has not been possible to replace specific defective layer portions, and the yield during production has also been low.

### CITATION LIST

### Patent Literature

[PTL 1] Japanese Unexamined Patent Publication No. 2014-116156
[PTL 2] Japanese Unexamined Patent Publication No. 2020-113434
[PTL 3] Japanese Unexamined Patent Publication No. 2016-9526

### SUMMARY

### Technical Problem

It is an object of the present disclosure to provide an all-solid-state battery with a novel construction.

### Solution to Problem

The construction for solving the problem described above is as follows:

### <Aspect 1>

An all-solid-state battery having at least one structural unit cell comprising a positive electrode collector layer, a positive electrode active material layer, a solid electrolyte layer, a negative electrode active material layer and a negative electrode collector layer stacked in that order,

wherein a connecting conductor layer is layered on the surface of the positive electrode collector layer side and/or the negative electrode collector layer side of the structural unit cell.

### <Aspect 2>

The all-solid-state battery according to aspect 1, wherein the electric resistivity of the connecting conductor layer is lower than the electric resistivity of the positive electrode collector layer or negative electrode collector layer on which the connecting conductor is layered.

### <Aspect 3>

The all-solid-state battery according to aspect 1 or 2, wherein the electric resistivity of the connecting conductor layer is 1×10⁻⁶ Ωm or lower.

### <Aspect 4>

The all-solid-state battery according to any one of aspects 1 to 3, wherein the connecting conductor layer is made of copper and/or aluminum.

### <Aspect 5>

The all-solid-state battery according to any one of aspects 1 to 4, wherein the negative electrode active material layer comprises a sulfide-based solid electrolyte, and the negative electrode collector layer is made of stainless steel or nickel.

### <Aspect 6>

A method for producing an all-solid-state battery according to any one of aspects 1 to 5, wherein the method comprises the following steps in order:

a step of alternately layering the structural unit cell and the connecting conductor layer or layering subunits of the layered structural unit cell and connecting conductor, to form a stack,

a step of connecting a positive electrode terminal and a negative electrode terminal to the connecting conductor layer of the obtained stack, and

a step of sealing the stack with an exterior body.

### Effects

According to the present disclosure it is possible to provide an all-solid-state battery having a novel construction.

### BRIEF DESCRIPTION OF DRAWINGS

FIG. 1 is a schematic diagram showing a structural unit cell 10A of an all-solid-state battery 1A according to a first embodiment of this disclosure.

FIG. 2 is a schematic diagram showing an all-solid-state battery 1A according to the first embodiment of the disclosure.

FIG. 3 is a plan view of an all-solid-state battery 1A according to the first embodiment of the disclosure, as seen from the stacking direction.

FIG. 4 is a schematic diagram showing an all-solid-state battery 1B according to a second embodiment of the disclosure.

FIG. 5 is a schematic diagram showing an all-solid-state battery 1C according to a third embodiment of the disclosure.

FIG. 6 is a schematic diagram showing an all-solid-state battery 1D according to a fourth embodiment of the disclosure.

FIG. 7 is a schematic diagram showing an all-solid-state battery 1E according to a fifth embodiment of the disclosure.

### DESCRIPTION OF EMBODIMENTS

### <All-Solid-State Battery>

The all-solid-state battery of the disclosure is an all-solid-state battery having a structural unit cell comprising a positive electrode collector layer, a positive electrode active material layer, a solid electrolyte layer, a negative electrode active material layer and a negative electrode collector layer stacked in that order, wherein a connecting conductor layer is layered on the surface of the positive electrode collector layer side and/or the negative electrode collector layer side of the structural unit cell.

The all-solid-state battery of the disclosure may have a monolayer structure with one structural unit cell, or a multilayer structure with a plurality of alternately layered structural unit cells and connecting conductor layers.

With a plurality of layered structural unit cells, it is possible to further increase the charge-discharge capacity per volume and to further reduce the internal resistance of the battery. If a connecting conductor layer is also provided between each of the structural unit cells in the all-solid-state battery of the disclosure, then the structural unit cells will not be joined together, resulting in a different construction from the construction disclosed in PTL 3 in which the stack is joined throughout, and therefore since it is possible to exchange only a specific structural unit cell when a problem has occurred in part of that structural unit cell, this structure can improve production yield.

A serial structure is a structure with stacking such that the positive electrode collector sides of the structural unit cells are disposed in contact with one of the sides of the connecting conductors and the negative electrode collector sides of the structural unit cells are disposed in contact with the other sides, and the polarities of the plurality of structural unit cells are in the same direction (bipolar structure), while a parallel structure is a structure with stacking such that the positive electrode collector sides of the structural unit cells are disposed in contact with both sides of the positive electrode connecting conductors, and the negative electrode collector sides of the structural unit cells are disposed in contact with both sides of the negative electrode connecting conductors, so that the polarities of the plurality of structural unit cells alternate in opposite directions (monopolar structure). A serial structure can increase the voltage of the battery. A parallel structure can further increase the charge-discharge capacity and further lower the internal resistance of the battery.

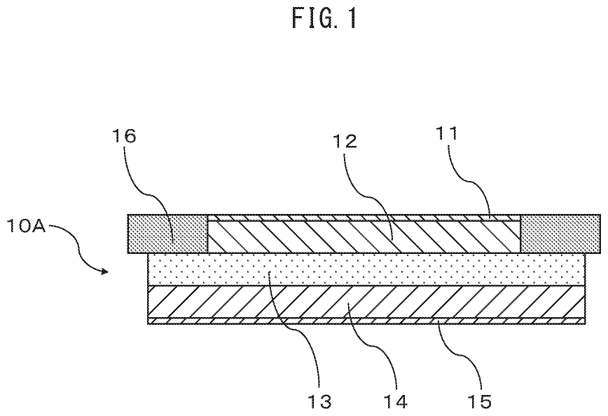

FIG. 1 is a schematic diagram showing a structural unit cell of an all-solid-state battery according to a first embodiment of the disclosure. FIG. 1 is not intended to limit the all-solid-state battery of this disclosure.

As shown in FIG. 1, the structural unit cell 10A of the all-solid-state battery 1A according to the first embodiment of the disclosure has a construction in which a positive electrode collector layer 11, positive electrode active material layer 12, solid electrolyte layer 13, negative electrode active material layer 14 and negative electrode collector layer 15 are stacked in that order. As seen from the stacking direction of the structural unit cell 10A, the positive electrode collector layer 11 and positive electrode active material layer 12 are disposed on the inner sides of the outer peripheries of the solid electrolyte layer 13, negative electrode active material layer 14 and negative electrode collector layer 15. An insulator 16 is disposed so as to surround the outer peripheries of the positive electrode collector layer 11 and positive electrode active material layer 12. The insulator 16 has a frame-like shape that surrounds the outer peripheries of the positive electrode collector layer 11 and positive electrode active material layer 12.

With the insulator 16 described above, the structural unit cell 10A can inhibit short circuiting caused by contact between the positive electrode collector layer 11 and/or positive electrode active material layer 12 and the negative electrode active material layer 14 and/or negative electrode collector layer 15.

In FIG. 1, the insulator 16 is disposed at the edges of the positive electrode collector layer 11 and positive electrode active material layer 12 so as to surround the entire outer peripheries of the positive electrode collector layer 11 and positive electrode active material layer 12, as seen from the stacking direction of the structural unit cell 10A. It is thus possible to fill the gaps formed between the positive electrode collector layer 11 and/or positive electrode active material layer 12 and the solid electrolyte layer 13 and/or negative electrode active material layer 14. The insulator 16 may also be disposed so as to surround the entire outer peripheries of the negative electrode active material layer 14 and negative electrode collector layer 15 as seen from the stacking direction.

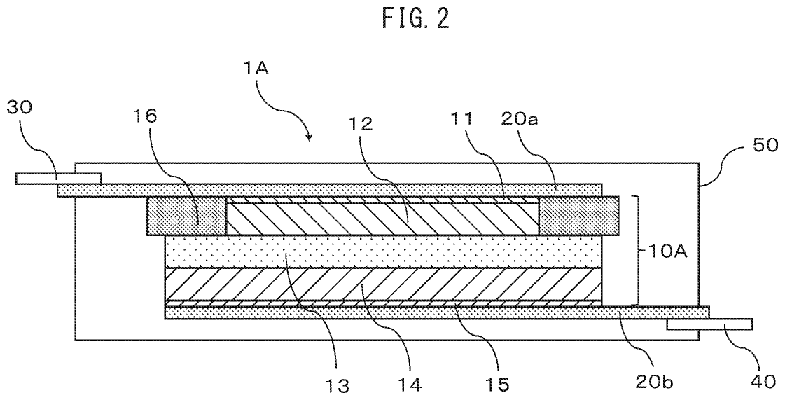

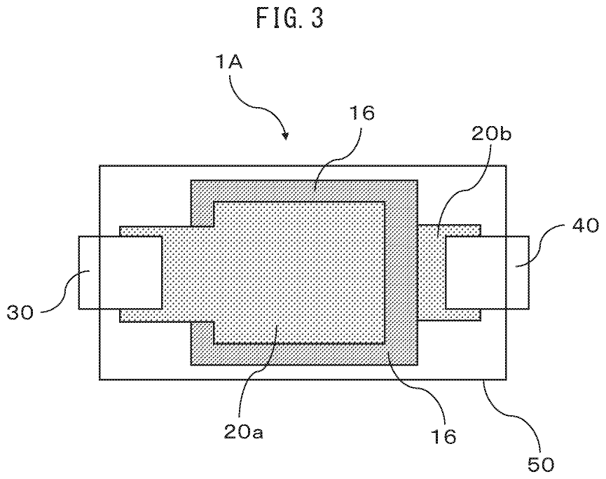

FIG. 2 is a schematic diagram showing an all-solid-state battery 1A according to the first embodiment of the disclosure. FIG. 3 is a plan view of an all-solid-state battery 1A according to the first embodiment of the disclosure, as seen from the stacking direction. FIGS. 2 and 3 are not intended to limit the all-solid-state battery of this disclosure.

In the all-solid-state battery 1A shown in FIG. 2 and FIG. 3, a positive electrode connecting conductor layer 20a and a negative electrode connecting conductor layer 20b are layered on the surface of the positive electrode collector layer 11 side and the surface of the negative electrode collector layer 15 side of the structural unit cell 10A, respectively. The structural unit cell 10A and the respective connecting conductor layers 20a, 20b are all disposed inside an exterior body 50. The positive electrode connecting conductor layer 20a is connected to a positive electrode terminal 30 and the negative electrode connecting conductor layer 20b is connected to a negative electrode terminal 40. The positive electrode terminal 30 and negative electrode terminal 40 each have a structure leading outward from the exterior body 50, allowing current to be extracted from them.

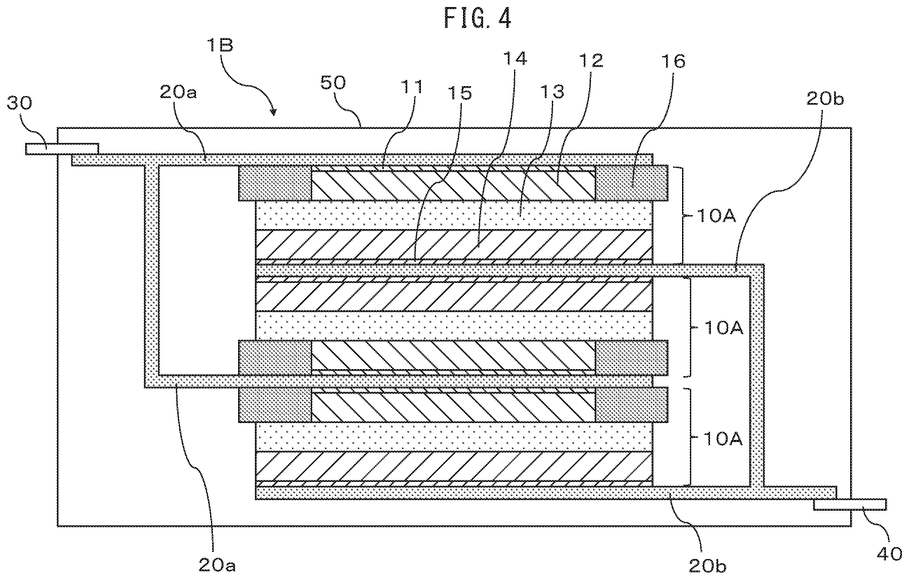

FIG. 4 is a schematic diagram showing an all-solid-state battery 1B according to the second embodiment of the disclosure. FIG. 4 is not intended to limit the all-solid-state battery of this disclosure.

The all-solid-state battery 1B of the second embodiment of the disclosure shown in FIG. 4 has a layered structure with three structural unit cells 10A connected in parallel (monopolar structure). The all-solid-state battery 1B has a layered structure stacked in such a manner that the negative electrode collector layer 15 of the structural unit cell 10A is in contact with the negative electrode connecting conductor layer 20b and the positive electrode collector layer 11 is in contact with the positive electrode connecting conductor layer 20a. Each structural unit cell 10A is alternately layered in reverse vertical polarity.

When a plurality of structural unit cells 10A are layered as shown in FIG. 4, the plurality of positive electrode connecting conductors layer 20a and negative electrode connecting conductor layers 20b are connected to the positive electrode terminal 30 and negative electrode terminal 40, respectively. The connection method may be the same as for a monolayer. They are sealed by the exterior body 50, with only parts of the positive electrode terminal 30 and negative electrode terminal 40 leading out from the exterior body 50.

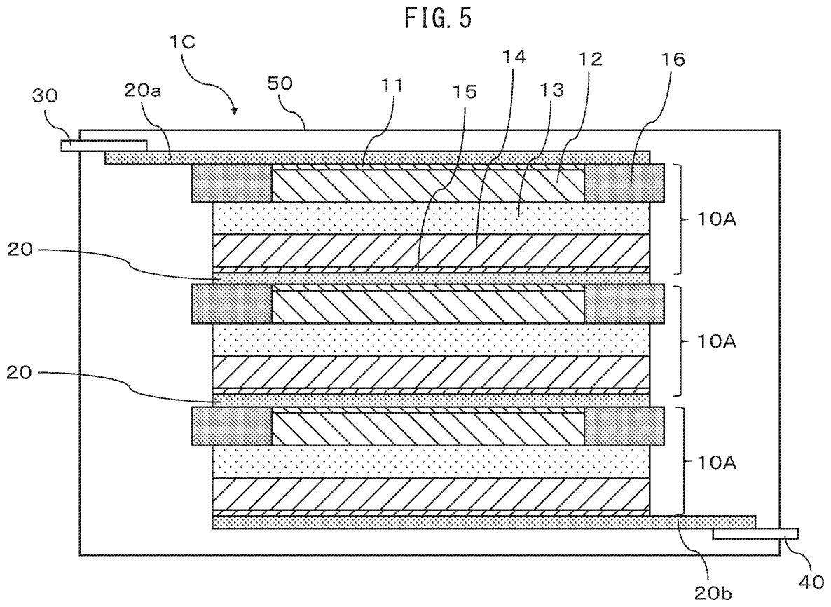

FIG. 5 is a schematic diagram showing an all-solid-state battery 1C according to the third embodiment of the disclosure. FIG. 5 is not intended to limit the all-solid-state battery of this disclosure.

The all-solid-state battery 1C of the third embodiment of the disclosure shown in FIG. 5 has a layered structure with three structural unit cells 10A connected in series (bipolar structure). The layered structure on both sides of each connecting conductor layer 20 is such that the negative electrode collector layer 15 of one structural unit cell 10A and the positive electrode collector layer 11 of another structural unit cell 10A are in contact. At both edges of the layered structural unit cells 10A in the stacking direction, the positive electrode connecting conductor layer 20a is layered on the surface of the positive electrode collector layer 11 side and the positive electrode terminal 30 is further connected to it, similar to a monolayer. The negative electrode connecting conductor layer 20b is also layered on the surface of the negative electrode collector layer 15 side, and the negative electrode terminal 40 is connected. These are sealed by the exterior body 50, with only parts of the positive electrode terminal 30 and negative electrode terminal 40 leading out from the exterior body 50.

In some embodiments, in the all-solid-state battery 1C shown in FIG. 5, the materials composing the connecting conductor layer 20, positive electrode connecting conductor layer 20a and negative electrode connecting conductor layer 20b are materials with low electric resistivity, examples of which include aluminum, copper, nickel and stainless steel (SUS). Two or more different types may also be used. In some embodiments, aluminum or copper is used among those mentioned above.

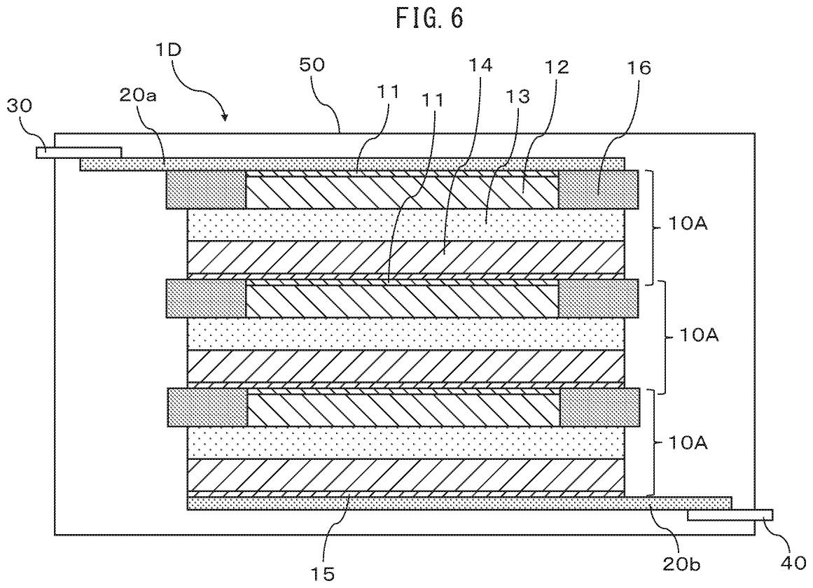

FIG. 6 is a schematic diagram showing an all-solid-state battery 1D according to the fourth embodiment of the disclosure. FIG. 6 is not intended to limit the all-solid-state battery of this disclosure.

The all-solid-state battery 1D of the fourth embodiment of the disclosure shown in FIG. 6 has a layered structure with a plurality of structural unit cells 10A connected in series. As compared to the all-solid-state battery 1C of FIG. 5, the all-solid-state battery 1D of the fourth embodiment has a bipolar structure without connecting conductor layers 20 between the structural unit cells 10A. By lacking the connecting conductor layers 20, the battery volume is reduced and the energy density of the battery can be increased.

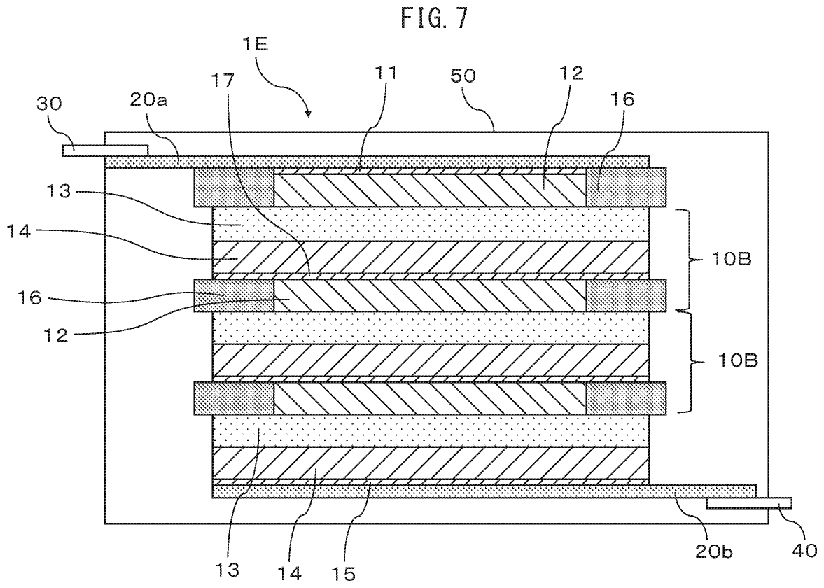

FIG. 7 is a schematic diagram showing an all-solid-state battery 1E according to the fifth embodiment of the disclosure. FIG. 7 is not intended to limit the all-solid-state battery of this disclosure.

The all-solid-state battery 1E of the fifth embodiment of the disclosure shown in FIG. 7 has a layered structure with two structural unit cells connected in series. Each structural unit cell 10B (coated on both sides) has a structure in which the negative electrode active material layer 14 and solid electrolyte layer 13 are disposed in that order on one side of a current collector layer 17, and the positive electrode active material layer 12 is disposed on the other side, with the insulator 16 disposed around the outer periphery. The all-solid-state battery 1E has a bipolar structure in which two structural unit cells 10B are layered with the solid electrolyte layer 13 and positive electrode active material layer 12 in contact.

As shown in FIG. 7, in each structural unit cell 10B, a stack comprising the positive electrode active material layer 12 coated on one side of the positive electrode collector layer 11 and with the insulator 16 disposed around the outer periphery, is disposed with the positive electrode active material layer 12 in contact with the edge on the solid electrolyte layer 13 side. The positive electrode terminal 30-connected positive electrode connecting conductor layer 20a is in contact with the positive electrode collector layer 11. In each structural unit cell 10B, a stack comprising the negative electrode active material layer 14 and solid electrolyte layer 13 coated in that order on one side of the negative electrode collector layer 15, is disposed with the solid electrolyte layer 13 in contact with the edge on the positive electrode active material layer 12 side. The negative electrode terminal 40-connected negative electrode connecting conductor layer 20b is in contact with the negative electrode collector layer 15. These are sealed by the exterior body 50, with only parts of the positive electrode terminal 30 and negative electrode terminal 40 leading out from the exterior body.

### <Structural Unit Cell>

The structural unit cell of the all-solid-state battery of the present disclosure has a construction in which a positive electrode collector layer, positive electrode active material layer, solid electrolyte layer, negative electrode active material layer and negative electrode collector layer are stacked in that order.

As seen from the stacking direction of the structural unit cell, the positive electrode collector layer and positive electrode active material layer are disposed on the inner side of the outer periphery of the solid electrolyte layer, negative electrode active material layer and negative electrode collector layer. As seen from the stacking direction of the structural unit cell, the positive electrode collector layer and positive electrode active material layer may also have their outer peripheries aligned with the solid electrolyte layer, in which case the positive electrode collector layer, positive electrode active material layer and solid electrolyte layer may be disposed on the inner sides of the outer peripheries of the negative electrode active material layer and negative electrode collector layer.

This is in order to cause the positive electrode active material layer, and especially the edges, to reliably face the solid electrolyte layer and negative electrode active material layer, thereby allowing lithium ions migrating from the positive electrode active material during charge to easily intercalate into the negative electrode active material. This can help prevent deposition of lithium metal onto the positive electrode active material layer surface and the interface between the positive electrode active material layer and solid electrolyte layer, thus inhibiting internal short circuiting of the structural unit cells.

In the construction in which the positive electrode collector layer and positive electrode active material layer are disposed on the inner sides of the outer peripheries of the solid electrolyte layer, negative electrode active material layer and negative electrode collector layer, the insulator may also be disposed in a manner surrounding the outer peripheries of the positive electrode collector layer and positive electrode active material layer. The insulator may have a frame-like shape that surrounds the outer peripheries of the positive electrode collector layer and positive electrode active material layer.

### (Positive Electrode Collector Layer)

In some embodiments, material composing the positive electrode collector layer is one that does not react when in contact with the solid electrolyte or upon charge-discharge within the action potential of the positive electrode, and that has low electric resistivity. Examples include aluminum, stainless steel (SUS, austenite, martensite, ferrite, and austenite-ferrite (biphase)) and nickel. Two or more different types may also be used. In some embodiments, aluminum is used among those mentioned above.

The positive electrode collector layer in the all-solid-state battery of the disclosure may be made of aluminum, stainless steel or nickel. These metals have low reactivity with sulfide-based solid electrolytes.

### (Positive Electrode Active Material Layer)

In some embodiments, the positive electrode active material layer is composed mainly of a positive electrode active material and a solid electrolyte.

Examples of positive electrode active materials include LiCoO₂, LiMnO₂, LiNiO₂, oxides of lithium ternary oxides of Ni, Co and Mn, lithium ternary oxides of Ni, Co and Al, and LiFePO₄. Two or more different types may also be used.

Examples of solid electrolytes include sulfide-based solid electrolytes such as Li₂S—P₂S₅ (Li₇P₃S₁₁), Li₁₀GeP₂S₁₂, Li₆PS₅Cl and Li₆PS₅I, and oxide-based solid electrolytes such as Li_{1.4}Al_{0.4}Ti_{1.6}(PO₄)₃, Li₇La₃Zr₂O₁₂ and Li_{1.5}Al_{0.5}Ge_{1.5}(PO₄)₃. Two or more different types may also be used. In some embodiments, sulfide-based solid electrolytes are used among those mentioned above. In some embodiments, when a sulfide-based solid electrolyte is to be used, the positive electrode active material surface may be coated with LiNbO₃ in order to inhibit reaction with the positive electrode active material.

### (Solid Electrolyte Layer)

The solid electrolyte layer is composed mainly of a solid electrolyte. The solid electrolyte may be any of the solid electrolytes mentioned above for composing the positive electrode active material layer.

### (Negative Electrode Active Material Layer)

In some embodiments, the negative electrode active material layer is composed mainly of a negative electrode active material and a solid electrolyte.

Negative electrode active materials include graphite, hard carbon, lithium titanate, titanium oxide, silicon and silicon oxide. Two or more different types may also be used.

The solid electrolyte may be any of the solid electrolytes mentioned above for composing the positive electrode active material layer.

### (Negative Electrode Collector Layer)

In some embodiments, the material composing the negative electrode collector layer is one that does not react when in contact with the solid electrolyte or upon charge-discharge within the action potential of the negative electrode, and that has low electric resistivity. Examples include stainless steel (SUS), carbon, nickel and copper. Two or more different types may also be used.

Examples of materials to compose the insulator include resins such as polyethylene terephthalate (PET), polyimide (PI) and polyphenylenesulfide (PPS), and ceramics such as alumina. Two or more different types may also be used.

In some embodiments, when the negative electrode active material layer in the all-solid-state battery of the disclosure comprises a sulfide-based solid electrolyte, the negative electrode collector layer is made of stainless steel or nickel. These metals have low reactivity with sulfide-based solid electrolytes.

### <Connecting Conductor Layer>

In the all-solid-state battery of the disclosure, the connecting conductor layer is layered on the surface of the positive electrode collector layer side and/or the surface of the negative electrode collector layer side of the structural unit cell.

By joining the positive electrode terminal and negative electrode terminal to the connecting conductor layer in the all-solid-state battery of the disclosure, it is possible to obtain a structure in which the positive electrode terminal and negative electrode terminal are not directly joined to the positive electrode collector layers and negative electrode collector layers of the structural unit cells. It is also possible to obtain a structure in which the positive electrode collector layers and negative electrode collector layers of the structural unit cells are simply layered without contact with the connecting conductor layer.

Unlike in a conventional all-solid-state battery having a construction with the positive electrode collector layers and negative electrode collector layers joined to the positive electrode terminal and negative electrode terminal, the all-solid-state battery of the disclosure thus makes it possible to easily separate the structural unit cells from the all-solid-state battery even when they have been assembled in the all-solid-state battery. Therefore, when a problem arises with any of the structural unit cells during the all-solid-state battery production process, for example, the problematic structural unit cell alone can be easily exchanged to a non-problematic structural unit cell.

It is therefore possible to eliminate waste of the other structural unit cells or other parts of the all-solid-state battery, thereby improving yields during production of the all-solid-state battery.

An all-solid-state battery can also be formed by alternately layering structural unit cells and connecting conductor layers (positive electrode connecting conductor layers and negative electrode connecting conductor layers). This can further facilitate production of the all-solid-state battery.

In some embodiments, the positive electrode connecting conductor layer and negative electrode connecting conductor layer have shapes that partially or fully cover the positive electrode collector layers and negative electrode collector layers, respectively. In some embodiments, while planar shapes are used from the viewpoint of further reducing electrical resistance per unit volume, they may also be lattice-like or mesh-like. The positive electrode connecting conductor layer and negative electrode connecting conductor layer may have the positive electrode terminal and negative electrode terminal connected at locations that do not overlap with the positive electrode collector layers and negative electrode collector layers, respectively. In some embodiments, the method of connection is ultrasonic welding or spot welding/resistance spot welding from the viewpoint of further reducing electrical resistance at the connected sections.

The electric resistivity of the positive electrode connecting conductor layer and negative electrode connecting conductor layer will be inversely proportional to the thickness. In some embodiments, a smaller thickness of the connecting conductor layer, on the other hand, increases the energy density per battery volume, and therefore smaller thicknesses are used for the positive electrode connecting conductor layer and negative electrode connecting conductor layer. Specifically, in some embodiments, a thickness of 100 μm or smaller is used, 50 μm or smaller is used, and 20 μm or smaller is used.

In some embodiments, the materials composing the positive electrode connecting conductor layer and negative electrode connecting conductor layer have low electrical resistance. Examples include aluminum, copper, nickel and stainless steel (SUS). Two or more different types may also be used. In some embodiments, the electric resistivity of the connecting conductor layer is lower than that of the positive electrode collector layer or negative electrode collector layer with which it contacts.

Specifically, in some embodiments, the electric resistivity of the positive electrode connecting conductor layer is lower than the electric resistivity of the positive electrode collector layer, and the electric resistivity of the negative electrode connecting conductor layer is lower than the electric resistivity of the negative electrode collector layer.

More specifically, in some embodiments, the electric resistivity of the connecting conductor layer is 1×10⁻⁶ Ωm or lower. The electric resistivity is measured according to JIS C2525:1999.

The electric resistivity of the connecting conductor layer may be 1×10⁻⁶ Ωm or lower, 5×10⁻⁷ Ωm or lower, 1×10⁻⁷ Ωm or lower or 5×10⁻⁸ Ωm or lower.

The method for lowering the electrical resistance of the connecting conductor layer may be, for example, a method of using a metal material having lower electric resistivity than the material forming the positive electrode collector layer or negative electrode collector layer, as the material to form the positive electrode connecting conductor layer or negative electrode connecting conductor layer, or a method of increasing the thickness of the connecting conductor to enlarge the cross-sectional area.

Specifically, the connecting conductor layer may be made of copper and/or aluminum.

When the all-solid-state battery of the disclosure uses a sulfide-based solid electrolyte as the solid electrolyte, the negative electrode collector layer and sulfide-based solid electrolyte can potentially react depending on the material employed for the negative electrode collector layer, thus increasing the internal resistance of the all-solid-state battery. In such cases a material with low reactivity with the sulfide-based solid electrolyte, such as stainless steel or nickel, may be used as the material of the negative electrode collector layer.

A metal such as stainless steel or nickel generally has high electric resistivity. For example, the electric resistivity of stainless steel is 10 or more times that of copper. If such a metal is used as the collector, therefore, the internal resistance of the all-solid-state battery as a whole will increase.

In this regard, in some embodiments, when a sulfide-based solid electrolyte is used as the solid electrolyte, a material having low reactivity with the sulfide-based solid electrolyte, such as stainless steel or nickel, is used as the current collector layer, and a material having low electric resistivity, such as aluminum or copper, is used as the connecting conductor layer disposed on the current collector layer. With such a construction it is possible to use a material having low reactivity with sulfide-based solid electrolytes in the current collector layer and to inhibit reaction of the current collector layer with the sulfide-based solid electrolyte, thereby inhibiting increase in internal resistance, while also offsetting the high electric resistivity of the current collector layer by the connecting conductor layer that has low electric resistivity, and reducing the internal resistance of the all-solid-state battery as a whole.

### <Terminals>

Examples of materials for the positive electrode terminal and negative electrode terminal include aluminum, copper and nickel. Two or more different types may also be used. A sealant film employing a thermoplastic resin such as polypropylene may also be disposed at a location in contact with the exterior body, creating a firm seal by thermocompression bonding.

### <Exterior Body>

The exterior body is formed of a laminate film, for example. In some embodiments, the exterior body has a gas barrier property in order to inhibit reaction of the solid electrolyte in the structural unit cell with moisture in the air atmosphere, which results in deterioration. In some embodiments, the exterior body is vacuum sealed to reduce interfacial resistance between the layers.

<Method for Producing all-Solid-State Battery>

The method for producing an all-solid-state battery according to the disclosure comprises, for example, a step of alternately layering a plurality of structural unit cells and connecting conductor layers or alternately layering a structural unit cell and connecting conductor layer, to form a stack, a step of connecting a positive electrode terminal and a negative electrode terminal to the connecting conductor layer of the obtained stack, and a step of sealing the stack with an exterior body, in that order.

The method for producing the all-solid-state battery 1A illustrated in FIGS. 2 and 3 may be, for example, a method for producing an all-solid-state battery 1A by a step of integrating a stack of a positive electrode collector layer 11 and positive electrode active material layer 12 and a stack of a solid electrolyte layer 13, negative electrode active material layer 14 and negative electrode collector layer 15, and disposing an insulator 16 to fabricate a structural unit cell 10A, a step of connecting a positive electrode connecting conductor layer 20a to a positive electrode terminal 30, a step of connecting a negative electrode connecting conductor layer 20b to a negative electrode terminal 40, a step of layering the structural unit cell 10A on the negative electrode connecting conductor layer 20b with the negative electrode collector layer 15 side in contact, and layering the positive electrode connecting conductor layer 20a on the positive electrode collector layer 11 side of the structural unit cell 10A, thereby forming a stack, and a subsequent step of sealing the stack with an exterior body 50 while leading out part of the positive electrode terminal 30 and negative electrode terminal 40.

Another method may comprise, in order, a step of anchoring a positive electrode terminal 30-connected positive electrode connecting conductor layer 20a and a negative electrode terminal 40-connected negative electrode connecting conductor layer 20b to an exterior body 50 in advance, and a step of inserting structural unit cells 10A between the positive electrode connecting conductor layer 20a and negative electrode connecting conductor layer 20b before sealing the exterior body 50.

In some embodiments, the former method is used to further facilitate production with stacking in order in the same direction.

The method for producing the all-solid-state battery 1B illustrated in FIG. 4 may be, for example, a method comprising the following steps in order: a step of integrating a stack of a positive electrode collector layer 11 and positive electrode active material layer 12 and a stack of a solid electrolyte layer 13, negative electrode active material layer 14 and negative electrode collector layer 15, and disposing an insulator 16 to fabricate a structural unit cell 10A, a step of layering each structural unit cell 10A with the negative electrode collector layer 15 in contact with the negative electrode connecting conductor layer 20b, and layering the positive electrode connecting conductor layer 20a on the positive electrode collector layer 11 side of the structural unit cell 10A, a step of alternately layering the structural unit cells 10A and the positive electrode connecting conductor layers 20a and negative electrode connecting conductor layers 20b, a step of connecting the plurality of positive electrode connecting conductor layers 20a to a positive electrode terminal 30 outside of the stack of structural unit cells 10A, a step of connecting the plurality of negative electrode connecting conductor layers 20b to a negative electrode terminal 40 outside of the stack of structural unit cells 10A, and a step of sealing the layered structure with an exterior body 50 while leading out part of the positive electrode terminal 30 and negative electrode terminal 40. The step of alternately layering the structural unit cells 10A and the positive electrode connecting conductor layers 20a and negative electrode connecting conductor layers 20b may be carried out, for example, by a method comprising a step of layering another structural unit cell 10A on the opposite side of the positive electrode connecting conductor layer 20a with its positive electrode collector layer 11 side in contact, and layering the negative electrode connecting conductor layer 20b on the negative electrode collector layer 15 side of the structural unit cell 10A, and a step of layering the structural unit cell 10A with the positive electrode connecting conductor layer 20a and negative electrode connecting conductor layer 20b by the same procedure, in that order.

The method for producing the all-solid-state battery 1C illustrated in FIG. 5 may be, for example, a method comprising the following steps in order: a step of fabricating a structural unit cell 10A in the same manner as the method for producing the all-solid-state battery 1B illustrated in FIG. 4, a step of connecting a positive electrode connecting conductor layer 20a to a positive electrode terminal 30, a step of connecting a negative electrode connecting conductor layer 20b to a negative electrode terminal 40, a step of alternately layering structural unit cells 10A and connecting conductor layers 20 to obtain a layered structure, and a step of inserting the layered structure between the positive electrode connecting conductor layer 20a and negative electrode connecting conductor layer 20b and sealing it with an exterior body 50 while leading out parts of the positive electrode terminal 30 and negative electrode terminal 40.

In the all-solid-state battery 1C shown in FIG. 5, the step of alternately layering the structural unit cells 10A and connecting conductor layers 20 may be a method comprising the following steps in order: a step of layering a structural unit cell 10A on a negative electrode connecting conductor layer 20b with the negative electrode collector layer 15 side in contact, and layering a connecting conductor layer 20 on the positive electrode collector layer 11 side of the structural unit cell 10A, a step of layering another structural unit cell 10A on the opposite side of the connecting conductor layer 20 with its negative electrode collector layer 15 side in contact, and layering a connecting conductor layer 20 on the positive electrode collector layer 11 side of the other structural unit cell 10A, a step of consecutively layering structural unit cells 10A and connecting conductor layers 20 by the same procedure, and a step of layering a final structural unit cell 10A and then layering a positive electrode connecting conductor layer 20a on the positive electrode collector layer 11 of the final structural unit cell 10A.

The method for producing the all-solid-state battery 1D shown in FIG. 6 may be the same method as for production of the all-solid-state battery 1C shown in FIG. 5, except that connecting conductor layers 20 are not disposed between adjacent structural unit cells 10A.

The method for producing the all-solid-state battery 1E illustrated in FIG. 7 may be, for example, a method comprising the following steps in order: a step of fabricating a structural unit cell 10B by layering a negative electrode active material layer 14 and a solid electrolyte layer 13 in that order on one side of a current collector layer 17, and disposing a positive electrode active material layer 12 on the surface of the opposite side of the current collector layer 17, with an insulator 16 surrounding it, a step of connecting a positive electrode connecting conductor layer 20a to a positive electrode terminal 30, a step of connecting a negative electrode connecting conductor layer 20b to a negative electrode terminal 40, a step of layering a negative electrode collector layer 15 and a structure comprising a negative electrode active material layer 14 and solid electrolyte layer 13 stacked in that order on the negative electrode connecting conductor layer 20b, a step of layering the positive electrode active material layer 12 side of the structural unit cell 10B on the solid electrolyte layer 13 side, a step of consecutively layering structural unit cells 10B by the same procedure, and a step of layering a stack comprising a positive electrode active material layer 12 on a positive electrode collector layer 11 with an insulator 16 disposed, on the solid electrolyte layer 13 side of the final structural unit cell 10B, with the positive electrode active material layer 12 side in contact. In another method, stacks among the structural unit cells 10A without a positive electrode collector layer 11 or negative electrode collector layer 15 are layered together and finally inserted between a positive electrode connecting conductor layer 20a and negative electrode connecting conductor layer 20b.

When the structural unit cells are layered, an adhesive may be coated onto some of the structural unit cells or insulators, positive electrode connecting conductor layers, negative electrode connecting conductor layers or connecting conductor layers to anchor them, in order to inhibit dislocation of the layered stack.

In the production method described above for all-solid-state batteries 1B to 1E illustrated in FIGS. 4 to 7, it is possible to disassemble the layered structure and easily remove the structural unit cells 10A, 10B after completion of the layering step. Therefore, when a defect has been found in one of the structural unit cells 10A, 10B after completion of the layering step, for example, a non-defective replacement can be easily made at that location alone, thus improving the yield during battery production.

In order to firmly join together each of the layers of a stacked structure of a plurality of structural unit cells and reduce interfacial resistance in a conventional stacked all-solid-state battery it has been necessary to press the stack as a whole, but because of the differences in sizes, materials, thicknesses and elastic moduli of the different layers, concentration of pressure at parts of the structure has tended to result in damage or short circuiting. The method for producing an all-solid-state battery as illustrated in FIGS. 4 to 7 allows layering of structural unit cells to be carried out after pressing, with the metal layers of the structural unit cells in contact with each other, thus lowering interfacial resistance and allowing the battery to be fabricated without pressing of the whole.

In the method for producing all-solid-state batteries 1B to 1E according to the present embodiment illustrated in FIGS. 4 to 7, the positive electrode connecting conductor layer 20a and negative electrode connecting conductor layer 20b, the connecting conductor layers 20, the structural unit cells 10A, 10B and the insulators 16 may be layered in any order so long as the final arrangement of the layers is as shown in the drawings. For example, in FIG. 4, the negative electrode collector layer 15 sides of every two structural unit cells 10A may first be integrated with both sides of the negative electrode connecting conductor layers 20b, before alternately stacking positive electrode connecting conductor layers 20a to fabricate the stack.

### EXAMPLES

### Examples 1 and 2 and Comparative Example 1

Examples of the present disclosure will now be described. However, the present disclosure is in no way limited by the examples. The evaluation methods used in the Examples and Comparative Examples will be explained first.

### <Measurement of Electric Resistivity>

The electric resistivities of the current collector layers and connecting conductor layers used in the Examples and Comparative Examples were measured according to JIS C2525:1999.

### <Battery Internal Resistance Evaluation>

All-solid-state batteries fabricated for the Examples and Comparative Examples were each subjected to a charge-discharge test at 25° C. and a 0.1 C rate while applying pressure through flat plates on either side, and the charge capacity and discharge capacity of each was measured to evaluate the internal resistance of the battery. For the C rate, 1 C is the current at which the battery is charged to full capacity in 1 hour, and 0.1 C is the current at which it is charged to full capacity in 10 hours.

This was followed by charging at 60° C., 2 C and measurement of the charge capacity, and subsequently discharge at a 0.1 C followed by measurement of the charge capacity at a 6 C, to evaluate the internal resistance of the battery.

### Example 1

### (Positive Electrode Active Material Layer and Positive Electrode Collector Layer)

Aluminum foil (electric resistivity: 2.7×10⁻⁸ Ωm, thickness: 20 μm) as the positive electrode collector layer was coated with a positive electrode active material slurry comprising a mixture of a LiNbO₃-coated lithium ternary oxide of Ni, Co and Mn (positive electrode active material), an argyrodite-based sulfide-based solid electrolyte, VGCF™-H carbon nanofibers (conductive aid) and an organic system binder, to form a positive electrode active material layer on the positive electrode collector layer.

### (Negative Electrode Active Material Layer and Negative Electrode Collector Layer)

A stainless steel foil (electric resistivity: 5.4×10⁻⁷ Ωm, thickness: 10 μm) as the negative electrode collector layer was coated with a negative electrode active material slurry comprising a mixture of graphite (negative electrode active material), an argyrodite-based sulfide-based solid electrolyte and an organic system binder, to form a negative electrode active material layer on the negative electrode collector layer.

### (Solid Electrolyte Layer)

A mixture of an argyrodite-based sulfide-based solid electrolyte and an organic system binder was coated onto a stainless steel foil to form a solid electrolyte layer.

### (Structural Unit Cell)

The aforementioned positive electrode active material layer, solid electrolyte layer and negative electrode active material layer were integrated to obtain a structural unit cell. The stainless steel foil of the solid electrolyte layer was detached during integration.

An all-solid-state battery composed of one structural unit cell was fabricated in the following manner. A stainless steel foil (electric resistivity: 5.4×10⁻⁷ Ω·m, thickness: 10 μm) as the positive electrode connecting conductor layer was connected with an aluminum positive electrode terminal by ultrasonic welding. A stainless steel foil as the negative electrode connecting conductor layer was similarly connected with a nickel-coated copper negative electrode terminal, by ultrasonic welding. The negative electrode collector layer side of the structural unit cell was layered onto the negative electrode connecting conductor layer, and an insulation film cut out to the same inside size as the positive electrode active material layer was disposed at the edge of the positive electrode active material layer of the structural unit cell. The connecting conductor layer of an aluminum foil (electric resistivity: 2.7×10⁻⁸ Ω·m, thickness: 20 μm) already connected to a lead was placed on the positive electrode collector layer side of the structural unit cell. The layered structure was vacuum sealed with an exterior body laminate film.

### Example 2

An all-solid-state battery was fabricated in the same manner as Example 1, except that an aluminum foil was used as the positive electrode connecting conductor layer and a copper foil (electric resistivity: 1.7×10⁻⁸ Ω·m, thickness: 17 μm) was used as the negative electrode connecting conductor layer.

### Comparative Example 1

An all-solid-state battery was fabricated in the same manner as Example 1, except that the structural unit cell was fabricated without using a positive electrode connecting conductor layer and negative electrode connecting conductor layer, but using a positive electrode collector layer with an aluminum foil having one side larger than the positive electrode active material layer, and a negative electrode collector layer with a copper foil having one side larger than the negative electrode active material layer, and a positive electrode terminal and negative electrode terminal were connected by ultrasonic welding outside of the layered region of the positive electrode collector layer and negative electrode collector layer.

The evaluation results for Examples 1 and 2 and Comparative Example 1 are shown in Table 1 below.

TABLE 1

| | Construction | | | | Result | | |
|---|---|---|---|---|---|---|---|
| | Positive | | | Negative | Discharge | Charge | Charge |
| | electrode | Positive | Negative | electrode | capacity at | capacity at | capacity at |
| | connecting | electrode | electrode | connecting | 25° C., 0.1 C | 60° C., 2.0 C | 60° C., 6.0 C |
| Example | conductor layer | collector layer | collector layer | conductor layer | (mAh/g) | (mAh/g) | (mAh/g) |
| Example 1 | Stainless steel | Aluminum | Stainless steel | Stainless steel | 173 | 173 | 133 |
| Example 2 | Aluminum | Aluminum | Stainless steel | Copper | 173 | 180 | 162 |
| Comp. Ex. 1 | None | Aluminum | Copper | None | 165 | 149 | 116 |

Examples 1 and 2 which employed stainless steel foils for the negative electrode collector layers, and also employed connecting conductor layers, had higher discharge capacity and charge capacity compared to Comparative Example 1. Example 2, which employed an aluminum foil as the positive electrode connecting conductor and a copper foil as the negative electrode connecting conductor, had an even higher charge capacity at 6 C.

### Examples 3 and 4 and Comparative Example 2

### Example 3

An all-solid-state battery for Example 3 was fabricated in the same manner as Example 1. However, the all-solid-state battery of Example 1 and the all-solid-state battery of Example 3 had slightly different basis weights of the positive electrode active material layer and negative electrode active material layer combinations.

### Example 4

A stacked all-solid-state battery for Example 4 was fabricated by layering ten of the structural unit cells fabricated in Example 3, in mutual parallel connection, and vacuum sealing with an exterior body laminate film.

### Comparative Example 2

A stacked all-solid-state battery for Comparative Example 2 was fabricated by layering in parallel ten structural unit cells fabricated in the same manner as Comparative Example 1 except for using an aluminum foil as the positive electrode collector layer and a stainless steel foil as the negative electrode collector layer, and vacuum sealing with an exterior body laminate film.

### <Battery Evaluation>

The all-solid-state battery of Example 3 and the stacked all-solid-state batteries of Example 4 and Comparative Example 2 were subjected to charge-discharge, and the charge capacities and discharge capacities were measured. The measurement results are shown in Table 2.

TABLE 2

| | Construction | | | | | | |
|---|---|---|---|---|---|---|---|
| | | Positive | | | Negative | Result | |
| | | electrode | Positive | Negative | electrode | Charge | Discharge |
| | Number of | connecting | electrode | electrode | connecting | capacity | capacity |
| Example | layers | conductor layer | collector layer | collector layer | conductor layer | (mAh) | (mAh) |
| Example 3 | 1 | Aluminum | Aluminum | Stainless steel | Copper | 159 | 158 |
| Example 4 | 10 | Aluminum | Aluminum | Stainless steel | Copper | 1528 | 1513 |
| Comp. Ex. 2 | 10 | None | Aluminum | Stainless steel | None | — | — |

As shown in Table 2, the stacked all-solid-state battery of Example 4 had approximately 10 times the charge capacity and discharge capacity of the all-solid-state battery of Example 3.

The stacked all-solid-state battery of Comparative Example 2, however, exhibited damage and short circuiting during layering.

### REFERENCE SIGNS LIST

1A, 1B, 1C, 1D, 1E All-solid-state battery
10A, 10B Structural unit cell
11 Positive electrode collector layer
12 Positive electrode active material layer
13 Solid electrolyte layer
14 Negative electrode active material layer
15 Negative electrode collector layer
16 Insulator
17 Current collector layer
20 Connecting conductor layer
20a Positive electrode connecting conductor layer
20b Negative electrode connecting conductor layer
30 Positive electrode terminal
40 Negative electrode terminal
50 Exterior body

1. An all-solid-state battery having at least one structural unit cell comprising a positive electrode collector layer, a positive electrode active material layer, a solid electrolyte layer, a negative electrode active material layer and a negative electrode collector layer stacked in that order, wherein a connecting conductor layer is layered on a surface of the positive electrode collector layer side and/or the negative electrode collector layer side of the structural unit cell.

2. The all-solid-state battery according to claim 1, wherein an electric resistivity of the connecting conductor layer is lower than the electric resistivity of the positive electrode collector layer or negative electrode collector layer on which the connecting conductor layer is layered.

3. The all-solid-state battery according to claim 1, wherein an electric resistivity of the connecting conductor layer is 1×10⁻⁶ Ωm or lower.

4. The all-solid-state battery according to claim 1, wherein the connecting conductor layer is made of copper and/or aluminum.

5. The all-solid-state battery according to claim 1, wherein the negative electrode active material layer comprises a sulfide-based solid electrolyte, and the negative electrode collector layer is made of stainless steel or nickel.

6. A method for producing an all-solid-state battery according to claim 1, wherein the method comprises the following steps in order: a step of alternately layering the structural unit cell and the connecting conductor layer, or layering subunits of the layered structural unit cell and connecting conductor, to form a stack, a step of connecting a positive electrode terminal and a negative electrode terminal to the connecting conductor layers of the obtained stack, and a step of sealing the stack with an exterior body.
